(19) United States
(12) Patent Application Publication
(10) Pub. No.: US 2026/0106764 A1
(43) Pub. Date: Apr. 16, 2026

(54) ELECTRONIC SIGNATURE DEVICE USING MULTIPLE ELECTRONIC SIGNATURE SCHEME AND ELECTRONIC SIGNATURE SYSTEM INCLUDING THE SAME

(71) Applicant: INSTITUTE FOR BASIC SCIENCE, Daejeon (KR)

(72) Inventor: Kyungah SHIM, Daejeon (KR)

(73) Assignee: INSTITUTE FOR BASIC SCIENCE, Daejeon (KR)

(21) Appl. No.: 18/946,581

(22) Filed: Nov. 13, 2024

(30) Foreign Application Priority Data
Oct. 14, 2024 (KR) 10-2024-0139448

(51) Int. Cl. H04L 9/32

(52) U.S. Cl. CPC H04L 9/3247

(57) ABSTRACT

An electronic device includes a communication device configured to exchange data with an external device, a memory configured to store data on a plurality of electronic signature schemes, and a processor configured to control the electronic device so that the electronic device performs a plurality of operations, wherein the plurality of operations includes generating a first electronic signature from plaintext based on a first electronic signature scheme, generating a second electronic signature from the plaintext based on a second electronic signature scheme, and generating a multiple electronic signature using the first electronic signature and the second electronic signature, both the first electronic signature scheme and the second electronic signature scheme are electronic signature schemes based on mathematical problems, and a first mathematical problem on which the first electronic signature scheme is based mathematically differs from a second mathematical problem on which the second electronic signature is based.

### TECHNICAL FIELD

Embodiments of the present disclosure relate to an encryption device and an encryption system, and more particularly, to an electronic signature device capable of generating and verifying an electronic signature, and an electronic signature system including the same.

### BACKGROUND ART

An electronic signature is electronic information attached to or logically combined with a specific electronic document to be used to check a signer and indicate that the signer has signed the electronic document.

A sender (signer) electronically signs a message he or she wants to send and sends the message to a recipient (verifier). After receiving the electronic signature, the recipient performs verification. In this process, the electronic signature guarantees authentication, non-repudiation, integrity, and the like of the sender.

Modern electronic signatures are based on public key encryption algorithms. In a public key encryption algorithm electronic signature, a sender electronically signs using his or her private key, and the recipient verifies the message using a sender's public key.

Meanwhile, the security of conventional public key encryption algorithms is threatened due to the development of quantum computers. In particular, classical public key encryption algorithms such as a Rivest-Shamir-Adleman (RSA) algorithm can be broken within a polynomial time according to Shor's algorithm, which can be implemented on quantum computers.

As an alternative, post-quantum encryption algorithms are proposed, but these algorithms have a problem that it is difficult to guarantee complete security due to the lack of long-term verification.

Considering the nature of electronic signatures that needs to guarantee long-term security, there is a need for a secure electronic signature scheme even in a quantum computer environment.

### SUMMARY OF INVENTION

### Technical Problem

The present disclosure is directed to providing an encryption device and an encryption system, which provide an encryption scheme capable of securing long-term security in a quantum computing environment.

In particular, the present disclosure is directed to providing an electronic signature device and a system including the same, which provide an electronic signature scheme capable of securing long-term security in a quantum computing environment.

### Solution to Problem

An electronic device according to embodiments of the present disclosure includes a communication device configured to exchange data with an external device, a memory configured to store data on a plurality of electronic signature schemes, and a processor configured to control the electronic device so that the electronic device performs a plurality of operations, wherein the plurality of operations includes generating a first electronic signature from plaintext based on a first electronic signature scheme, generating a second electronic signature from the plaintext based on a second electronic signature scheme, and generating a multiple electronic signature using the first electronic signature and the second electronic signature, both the first electronic signature scheme and the second electronic signature scheme are electronic signature schemes based on mathematical problems, and a first mathematical problem on which the first electronic signature scheme is based mathematically differs from a second mathematical problem on which the second electronic signature is based.

An electronic device according to embodiments of the present disclosure includes a communication device configured to exchange data with an external device, a memory configured to store data on a plurality of electronic signature schemes, and a processor configured to control the electronic device so that the electronic device performs a plurality of operations, wherein the plurality of operations include receiving a multiple electronic signature, identifying a first electronic signature based on a first electronic signature scheme from the multiple electronic signature and a second electronic signature based on a second electronic signature scheme, and verifying one of the first electronic signature and the second electronic signature, both the first electronic signature scheme and the second electronic signature scheme are electronic signature schemes based on mathematical problems, and a first mathematical problem on which the first electronic signature scheme is based mathematically differs from a second mathematical problem on which the second electronic signature is based.

A method of operating an electronic device according to embodiments of the present disclosure may be implemented in the form of a program stored in a computer-readable nonvolatile storage medium.

### Advantageous Effects of Invention

According to the embodiments of the present disclosure, since at least two encryption schemes based on different mathematical problems are used in encrypted communication, even when the mathematical problem of one encryption scheme is broken and its security is compromised, the security of the encryption scheme based on the other mathematical problem cannot be compromised. Therefore, the security of the overall encrypted communication can be ensured.

In particular, according to the embodiments of the present disclosure, since at least two electronic signature schemes among two or more electronic signature schemes are based on different mathematical problems, even when one electronic signature scheme is broken, the security of the electronic signature can be ensured, and in particular, high security can be expected even in a long-term environment.

### BRIEF DESCRIPTION OF DRAWINGS

Detailed description of each drawing is provided for better understanding for the accompanying drawings cited in the detailed specification of the present disclosure.

FIG. 1 shows an encryption system according to the embodiments of the present disclosure.

FIG. 2 shows an electronic device according to the embodiments of the present disclosure.

FIGS. 3 and 4 are views for describing an electronic signature operation according to the embodiments of the present disclosure.

FIG. 5 is a view for describing an operation of generating an electronic signature according to the embodiments of the present disclosure.

FIG. 6 is a view for describing a process of verifying an electronic signature according to the embodiments of the present disclosure.

### DESCRIPTION OF EMBODIMENTS

FIG. 1 shows an encryption system according to embodiments of the present disclosure. Referring to FIG. 1, a first electronic device 100 and a second electronic device 200 may perform encrypted communication based on an encryption scheme. The first electronic device 100 may correspond to an encryption device for encrypting plaintext to generate ciphertext, and the second electronic device 200 may correspond to a decryption device for decrypting ciphertext to acquire plaintext.

The electronic devices 100 and 200 and a server 300 are electronic devices including a calculation processing device and a communication circuit, such as a server computer, a mobile terminal, or a computer, but are not limited thereto.

The electronic devices 100 and 200 may perform an encryption operation by storing a program that performs an encryption operation and loading an electronic signature program. According to embodiments, the electronic devices 100 and 200 may store an encryption program for performing an encryption operation based on a public key encryption algorithm.

Here, the encryption operation based on the public key encryption algorithm may be an operation based on all encryption schemes using a public key method, and the encryption schemes using the public key method may include an electronic signature, a key encapsulation mechanism, key distribution, key agreement, aggregate signature, homomorphic encryption, functional encryption, functional signature, and the like, but are not limited thereto.

In addition, the encryption schemes using the above public key method may be based on specific mathematical problems. For example, the encryption scheme may be based on one of a lattice problem, a code problem, a multiplicative variable quadratic problem, an isogeny problem, a hash function problem, an integer factorization problem, a discrete logarithm problem, an elliptic-curve discrete logarithm problem, a multiparty computation (MPC)-in-the-head problem, and a symmetric-based problem, but embodiments of the present disclosure are not limited thereto.

In the present specification, each of the above mathematical problems, that is, the lattice problem, the code problem, the multiplicative variable quadratic problem, the isogeny problem, the hash function problem, the integer factorization problem, the discrete logarithm problem, and the elliptic curve discrete logarithm problem, is defined as a different mathematical problem.

Meanwhile, here, the lattice problem, the code problem, the multiplicative variable quadratic problem, the isogeny problem, and the hash function problem are secure mathematical problems from quantum computing attacks, while the integer factorization problem, the discrete logarithm problem, and the elliptic-curve problem are unsecured mathematical problems from quantum computing attacks.

The lattice problem is a problem related to finding the shortest vector on a predetermined lattice. For example, the lattice-based problem may include a learning with errors (LWE) problem and a short integer solution (SIS) problem on the lattice.

The code problem is a problem related to decoding general linear codes. For example, the code problem includes a syndrome decoding problem. For example, the encryption scheme based on a sign problem includes McEliece, Modern McEliece, Niederreiter, MCPC-McEliece, Wild McEliece, McBits, and the like, but is not limited thereto.

The multiplicative variable quadratic problem is a problem related to finding solutions to systems of multivariate quadratic defined on a finite field or a Galois field.

The isogeny problem is a problem related to finding isogeny between two elliptic curves.

The hash function problem is a problem related to a hash function that is a one-way function and includes, for example, a problem of finding a collision or second preimage of the hash function.

The integer factorization problem is a problem related to deriving p and q from N in which N is the product of two prime numbers p and q.

The discrete logarithm problem is a problem related to deriving x from y, g, and p (i.e., deriving x=log_{g}y on a finite field) when y=g^{x} mod p with respect to positive integers g, x, and p on the finite field.

The elliptic-curve discrete logarithm problem is a problem related to finding the corresponding multiple in the relationship between one point on an elliptic curve and the multiple of the above point.

The MPC-in-the-head problem is a problem related to a prover simulating a secure MPC protocol between multiple virtual parties in his or her head.

The symmetric-based problem is a problem related to a symmetric key encryption algorithm.

According to embodiments of the present disclosure, the electronic devices 100 and 200 may perform encrypted communication using two or more encryption schemes.

In particular, at least two encryption schemes among the two or more encryption schemes may be based on different mathematical problems. Therefore, even when the encryption scheme is broken, the entire plaintext is not exposed as long as the remaining encryption schemes are secured, and thus relatively high security can be expected even in a long-term environment.

The first electronic device 100 may use at least two encryption schemes among a plurality of encryption schemes to encrypt a message M.

According to embodiments, the first electronic device 100 stores at least two message seeds. The message seeds are seeds for acquiring the message, and when the two message seeds are processed according to a predetermined function, the message may be acquired. For example, the predetermined function may be a concatenate function, but is not limited thereto.

In addition, the first electronic device 100 stores data on the plurality of encryption schemes.

The first electronic device 100 encrypts a first message seed based on a first encryption scheme to generate a first ciphertext and encrypts a second message seed based on a second encryption scheme to generate a second ciphertext.

In this case, the first encryption scheme and the second encryption scheme may be based on different mathematical problems.

According to embodiments, the first encryption scheme may be an unsecured encryption scheme against quantum computing attacks, while the second encryption scheme may be based on a secure mathematical problem against quantum computing attacks. That is, at least one encryption scheme may be a secure encryption scheme against quantum computing attacks. Alternatively, both the first encryption scheme and the second encryption scheme are based on secure mathematical problems against quantum computing attacks, but may be based on different mathematical problems.

The first electronic device 100 transmits the generated first ciphertext and second ciphertext to the second electronic device 200. In this case, according to embodiments, the first electronic device 100 may generate multi-ciphertext based on the first ciphertext and the second ciphertext and transmit the multi-ciphertext to the second electronic device 200.

The second electronic device 200 may decrypt at least one of the first ciphertext and the second ciphertext to acquire the message M. According to embodiments, the second electronic device 200 may decrypt only one of the first ciphertext and the second ciphertext or decrypt both the first ciphertext and the second ciphertext.

For example, when the encrypted communication between the first electronic device 100 and the second electronic device 200 is a key encapsulation mechanism for session key exchange, the message may correspond to a session key, and the message seeds and may correspond to key seeds. In this case, the second electronic device 200 may decrypt the first ciphertext to acquire the first key seed, decrypt the second ciphertext to acquire the second key seed, and acquire the session key from the key seeds.

In addition, for example, when the encrypted communication between the first electronic device 100 and the second electronic device 200 is electronic signature communication, the ciphertexts may correspond to an electronic signature. In this case, the second electronic device 200 may decrypt only one of the first electronic signature S1 or the second electronic signature S2 and proceed with a verification procedure.

According to embodiments of the present disclosure, at least two encryption schemes based on different mathematical problems are used during encrypted communication. Therefore, even when the mathematical problem of one encryption scheme is broken and security is compromised, the security of the encryption scheme based on the other mathematical problem cannot be compromised. Therefore, the security of the overall encrypted communication can be ensured.

FIG. 1 shows an electronic signature system according to the embodiments of the present disclosure. FIG. 1 can be understood as an example of the encryption system. Referring to FIG. 1, the encryption system includes the first electronic device 100, the second electronic device 200, and the server 300.

The first electronic device 100 may be a signature device for generating an electronic signature for the message M, and the second electronic device 200 may be a verification device for verifying the electronic signature.

The electronic signature system according to embodiments of the present disclosure may be based on two or more electronic signature schemes rather than one electronic signature scheme. In particular, at least two of the two or more electronic signature schemes may be based on different mathematical problems. Therefore, even when one electronic signature scheme is broken, the security of the electronic signature can be ensured as long as the remaining electronic signature schemes are secured, and in particular, high security can be achieved even in a long-term environment.

The first electronic device 100 stores data on the message M and a plurality of electronic signature schemes SS1, SS2, SS3, SS4, . . . . The first electronic device 100 may generate a multiple electronic signature MS based on the message M and at least two electronic signature schemes SS1 and SS2.

In this case, a first electronic signature scheme SS1 and a second electronic signature scheme SS2 may be based on different mathematical problems. According to embodiments, the first electronic signature scheme SS1 is an unsecured electronic signature scheme against quantum computing attacks, while the second electronic signature scheme SS2 may be based on a secure mathematical problem against quantum computing attacks. That is, at least one electronic signature scheme may be a secure electronic signature scheme against quantum computing attacks. For example, the first electronic signature scheme SS1 may be based on the integer factorization problem, and the second electronic signature scheme SS2 may be based on the hash function problem.

Alternatively, both the first electronic signature scheme SS1 and the second electronic signature scheme SS2 may be based on secure mathematical problems against quantum computing attacks, but may be based on different mathematical problems. For example, the first electronic signature scheme SS1 may be based on the lattice problem, and the second electronic signature scheme SS2 may be based on the hash function problem.

According to embodiments, the first electronic device 100 generates a first electronic signature S1=SS1(M) from the message M based on the first electronic signature scheme SS1. In addition, the first electronic device 100 generates a second electronic signature S2=SS2(M) from the message M based on the second electronic signature scheme SS2.

Meanwhile, in the present specification, both the first electronic signature S1 and the second electronic signature S2 are described as being generated from the same message M, but according to embodiments, the first electronic signature S1 may be generated from a first message, and the second electronic signature S2 may be generated from a second message. In this case, the first message and the second message may be the same, similar, or different.

The first electronic signature scheme SS1 and the second electronic signature scheme SS2 may be selected according to an input of a user of the first electronic device 100 or selected according to a predetermined criterion defined in advance.

According to embodiments, the electronic device 100 may store selection information used to select two or more electronic signature schemes SS1 and SS2 to be used for the multiple electronic signature MS and select the first electronic signature scheme SS1 and the second electronic signature scheme SS2 based on the corresponding selection information to generate the multiple electronic signature MS.

Alternatively, the electronic device 100 may select the first electronic signature scheme SS1 and the second electronic signature scheme SS2 based on information (a calculation speed, a memory capacity, and the like) about the electronic device 100 and information (size or length of a message) about the message M to generate the multiple electronic signature MS.

The generated multiple electronic signature MS may be transmitted to the second electronic device 200 (i.e., a verification device).

The first electronic device 100 generates the multiple electronic signature MS based on the first electronic signature S1 and the second electronic signature S2. According to embodiments, the first electronic device 100 may concatenate the first electronic signature S1 and the second electronic signature S2 and generate the multiple electronic signature MS including the result of the concatenation.

That is, the multiple electronic signature MS may include both data on the first electronic signature S1 according to the first electronic signature scheme SS1 and the second electronic signature S2 according to the second electronic signature scheme SS2.

According to embodiments, the multiple electronic signature MS may further include information indicating that at least two electronic signatures S1 and S2 are included in the multiple electronic signature MS. Based on the corresponding information, the second electronic device 200 may read (or identify) the first electronic signature S1 and the second electronic signature S2 from the multiple electronic signature MS.

In addition, according to embodiments, the multiple electronic signature MS may further include information about a time point when the multiple electronic signature MS is generated. Based on the corresponding information, the second electronic device 200 may determine whether to verify the security of the first electronic signature S1 and the second electronic signature S2 that are included in the multiple electronic signature MS.

The second electronic device 200 may be a verification device for verifying the multiple electronic signature MS.

The second electronic device 200 may receive the multiple electronic signature MS and recognize (identify) the first electronic signature S1 and the second electronic signature S2 that are included in the multiple electronic signature MS.

The second electronic device 200 may recognize the first electronic signature S1 and the second electronic signature S2 from the multiple electronic signature MS and verify the first electronic signature S1 or the second electronic signature S2.

The second electronic device 200 may selectively verify one of the first electronic signature S1 and the second electronic signature S2 that are included in the multiple electronic signature MS. In particular, according to embodiments of the present disclosure, the second electronic device 200 may verify the remaining electronic signatures excluding the electronic signature corresponding to the electronic signature scheme determined to be unsecured in consideration of the security of the electronic signature schemes used when generating the electronic signature. For example, the second electronic device 200 may verify only the electronic signature (e.g., the remaining electronic signatures (e.g., the second electronic signature S2) excluding the first electronic signature S1) corresponding to the electronic signature scheme (e.g., the first electronic signature scheme SS1) determined to be unsecured among the electronic signatures S1 and S2. This will be described below.

According to embodiments, the second electronic device 200 may receive attack information ATI to each of the electronic signature schemes from an external server 300 and determine the unsecured electronic signature scheme based on the attack information ATI. The attack information ATI may include information indicating an unsecured electronic signature scheme due to attacks among the electronic signature schemes SS1, SS2, SS3, SS4 . . . .

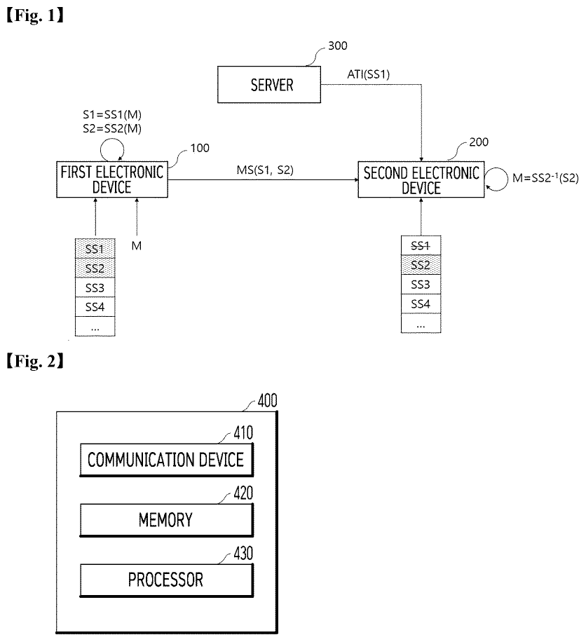

FIG. 2 shows an electronic device according to the embodiments of the present disclosure. Referring to FIG. 2, an electronic device 400 may be the electronic devices 100 and 200 of FIG. 1.

The device 400 may include a communication circuit 410, a memory 420, and a processor 430.

The communication circuit 410 may exchange data with an external device. According to embodiments, the communication circuit 410 may exchange data according to a wired communication protocol or a wireless communication protocol. For example, the communication circuit 410 may exchange information required to perform one or more encryption operations performed by the electronic device 400. In addition, the communication circuit 410 may exchange data with the external server 300.

The memory 420 may store data required for the operation of the device 400. According to embodiments, the memory 420 may store a program including commands for performing various encryption operations. The device 400 may perform the encryption operation by executing the program stored in the memory 420. For example, the memory 420 may store commands (i.e., algorithms) for performing electronic signature schemes used in an electronic signature operation.

The memory 420 may be a volatile memory or a non-volatile memory.

The processor 430 may control the overall operation of the device 400. According to embodiments, the processor 430 may have a calculation processing function and perform a specific operation. For example, the processor 430 may execute the program stored in the memory 420 and perform an encryption operation indicated by commands included in the program according to the execution.

For example, the processor 430 may be one of a central processing unit (CPU), a micro controller unit (MCU), a field programmable gate array (FPGA), an application specified integrated circuit (ASIC), and a graphical processing unit (GPU), but the embodiments of the present disclosure are not limited thereto.

The operation of the device 400 according to the embodiments of the present disclosure may be implemented in the form of a program stored in a computer-readable nonvolatile storage medium.

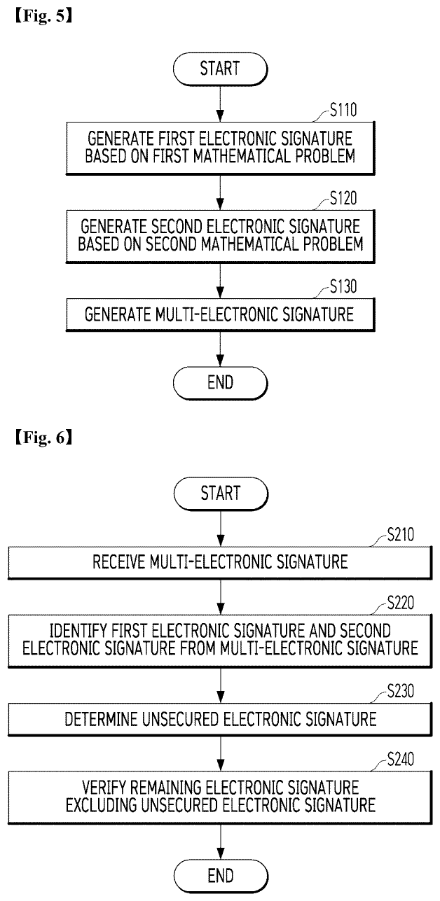

FIGS. 4 and 5 are views for describing an electronic signature operation according to the embodiments of the present disclosure. Referring to FIGS. 4 and 5, a signer is a person (or device) for generating an electronic signature, and a verifier is a person (or device) for verifying the signer's electronic signature.

When the signer generates the first electronic signature SS1(M) from the message M using the first electronic signature scheme SS1, the verifier may verify the first electronic signature SS1(M) using the first electronic signature scheme SS1.

To maintain the security of the electronic signature, the security of the electronic signature scheme (i.e., algorithm) performing the electronic signature needs to be ensured. In most cases, when the electronic signature scheme is secured when the electronic signature is generated, it is highly likely that the electronic signature scheme will still be secured when verified later.

However, in many cases, electronic signatures need to be stored for a long time (e.g., 10 years or longer), and when quantum computing is developing rapidly, even when the electronic signature scheme is secured when the electronic signature is generated, the security of the corresponding electronic signature scheme can be weakened when verifying the electronic signature after a considerable amount of time has elapsed.

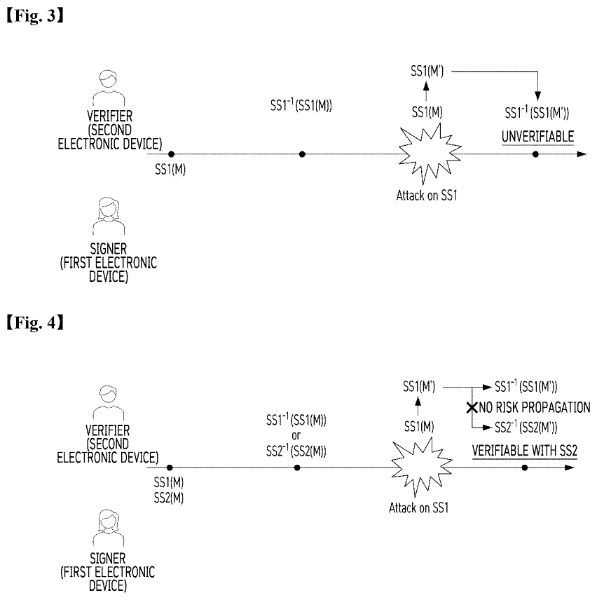

For example, as shown in FIG. 3, at a first verification time point, an attack on the first electronic signature scheme SS1 is not performed, and thus the security of the first electronic signature can be maintained to perform normal verification.

On the other hand, after a considerable amount of time has elapsed, an attack on the first electronic signature scheme SS1 may be performed, and thus the first electronic signature scheme SS1 cannot be secured. In this case, the message M of the first electronic signature previously generated by an attacker may be changed to a forged message M′, and in this case, there is a problem that the security of the first electronic signature is not ensured at a second electronic signature verification time point. That is, electronic signature verification is actually impossible.

As shown in FIG. 4, according to the embodiments of the present disclosure, the signer uses both the first electronic signature scheme SS1 and the second electronic signature scheme SS2. The second electronic signature scheme SS2 may differ from the first electronic signature scheme SS1. For example, the first electronic signature scheme SS1 and the second electronic signature scheme SS2 may be based on different mathematical problems.

That is, the signer generates the first electronic signature SS1(M) according to the first electronic signature scheme SS1 and the second electronic signature SS2(M) according to the second electronic signature scheme SS2.

According to embodiments, the signer may generate a multiple electronic signature including information about both the first electronic signature SS1(M) and the second electronic signature SS2(M).

The verifier may verify one of the first electronic signature SS1(M) and the second electronic signature SS2(M). According to embodiments, the verifier may recognize the first electronic signature SS1(M) and the second electronic signature SS2(M) that are included in the multiple electronic signature and verify one of the first electronic signature SS1(M) and the second electronic signature SS2(M).

According to the embodiments of the present disclosure, even when an attack is applied to the first electronic signature scheme SS1 after a considerable amount of time has elapsed since the first verification time, verification can be performed securely.

Even when it is determined that the first electronic signature scheme SS1 is not secured due to an attack, the security of the second electronic signature scheme SS2 different from the first electronic signature scheme SS1 is not compromised, and thus the verifier may securely perform verification by alternatively verifying the second electronic signature SS2(M) included in the multiple electronic signature. In particular, even when the first electronic signature scheme SS1 is not secured and the message M of the first electronic signature is changed to the forged message M′, such forge does not affect the second electronic signature SS2(M), and thus the verification of the second electronic signature SS2(M) may be performed validly.

In particular, according to the embodiments of the present disclosure, since the first electronic signature scheme SS1 and the second electronic signature scheme SS2 are based on different mathematical problems, even when the first electronic signature scheme SS1 is not secured by being compromised by an attack, the second electronic signature scheme SS2 may be very likely to be secured, thereby increasing the overall security of the electronic signature.

Therefore, the electronic signature system according to the embodiments of the present disclosure can ensure long-term security.

FIG. 5 is a view for describing an operation of generating an electronic signature according to the embodiments of the present disclosure.

Referring to FIG. 5, a signature device (i.e., a first electronic device) generates a first electronic signature from a plaintext message based on a first electronic signature scheme (S110).

The signature device generates a second electronic signature from a plaintext message based on a second electronic signature scheme (S120). In this case, the second electronic signature scheme may be based on a different mathematical problem from the first electronic signature scheme.

The signature device generates a multiple electronic signature based on the first electronic signature and the second electronic signature (S130).

Meanwhile, according to embodiments, before generating the multiple electronic signature, the signature device may receive information about the properties (e.g., a length, a storage period, and a security level) of the electronic signature from a user of the signature device and select electronic signature schemes to be used for the multiple electronic signature based on the corresponding information.

FIG. 6 is a view for describing a process of verifying an electronic signature according to the embodiments of the present disclosure.

Referring to FIG. 6, a verification device (i.e., a second electronic device) receives a multiple electronic signature (S210).

The verification device identifies a first electronic signature and a second electronic signature from the multiple electronic signature (S220).

The verification device determines which of the first electronic signature and the second electronic signature is unsecured (S230).

The verification device verifies the remaining electronic signatures excluding the electronic signature determined to be unsecured (S240). According to embodiments, when both the first electronic signature and the second electronic signature are secure electronic signatures, the verification device may select and verify only one of the first electronic signature and the second electronic signature.

The above description is merely the exemplary description of the technical spirit of the present disclosure, and those skilled in the art to which the present disclosure pertains will be able to variously modify and change the present disclosure without departing from the essential characteristics of the present disclosure. Therefore, the embodiments disclosed in the present invention are not intended to limit the technical spirit of the present invention, but intended to describe the same, and the scope of the technical spirit of the present invention is not limited by these embodiments. The scope of the present disclosure should be construed by the appended claims, and all technical ideas within the equivalent scope should be construed as being included in the scope of the present disclosure.

The above-described device (unit) may be implemented as a hardware element and/or a software element. For example, the hardware element may include a microphone, an amplifier, a bandpass filter, an A/D converter, and a processing device. The processing device may be implemented by using one or more general-purpose or special-purpose computers such as include, for example, a processor, a controller, an arithmetic logic unit (ALU), a digital signal processor, a microcomputer, a FPGA, a programmable logic unit (PLU), a microprocessor, or other devices capable of responding to and executing instructions in a defined manner. The processing device may run an operating system (OS) and one or more software applications running on the operating system. In addition, the processing device may access, store, manipulate, process, and generate data in response to the execution of software. For simple description, the processing device may be described as one, but those skilled in the art can know that the processing device may include multiple processing elements and/or multiple types of processing elements. For example, the processing device may include a plurality of processors or a processor and a controller. In addition, other processing configurations, such as parallel processors, are possible.

Software may include computer programs, code, instructions, or combinations thereof, which may independently or collectively configure or instruct the processing device to operate as desired. The software and data may be expressed as propagated signal waves that may be interpreted by and may provide instructions or data to a processing device, or may be embodied permanently or temporarily in various types of machines, components, physical devices, virtual devices, computer storage media or devices, etc. The software may be distributed over networked computer systems and thus stored and executed in a distributed manner. The software and data may be stored in one or more computer-readable recording media, which includes a data storage device for storing data and then readable by the computer system or the processing device. A method according to the embodiment may be implemented in a form of program instructions that may be performed through various computer devices and recorded on a computer-readable medium. Examples of computer-readable recording media include a ROM, a RAM, a CD-ROM, a magnetic tape, a floppy disk, and an optical data storage device. Examples of the computer-readable recording medium include magnetic media such as a hard disk, a floppy disk, and a magnetic tape, optical media such as a CD-ROM and a DVD, and magneto-optical media such as a floptical disk, and hardware devices specifically configured to store and execute program instructions, such as a ROM, a RAM, and a flash memory. In addition, the functional programs, code, and code segments that complete the examples disclosed herein can be easily understood and implemented by a programmer having ordinary skill in the art related to these examples based on or using the flowchart and block diagrams of the drawings and the related descriptions provided herein.

Although not universal, the terminals or devices described herein may be applied to mobile devices such as a cellular phone, a PDA, a digital camera, a portable game console, an MP3 player, a portable/personal multimedia player (PMP), a portable e-book, a portable laptop PC, a GPS navigation system, a tablet PC, and a sensor, a desktop PC, a HDTV, an optical disc player, a set-top box, home appliance, and devices capable of wireless or network communication.

In addition, the computer-readable medium may include program instructions, data files, data structures, etc. alone or in combination. The program instructions recorded on the medium may be specially designed and constructed for the embodiments or may be known and available to those skilled in the art of computer software. Examples of the program instructions include not only machine language code such as that produced by a compiler but also high-level language code that may be executed by a computer using an interpreter, etc. The hardware device may be configured to operate as one or more software modules to perform the operation of the embodiments, and vice versa.

Although several embodiments have been described above, it should be understood that various modifications can be made. For example, appropriate results can be achieved even when the techniques described are performed in a different order and/or elements of the stated system, structure, device, circuit, etc. are coupled in a different way or replaced with or supplemented by other elements or equivalents. Therefore, other implementations also fall within the scope of the appended claims.

1. An electronic device comprising:
a communication device configured to exchange data with an external device;
a memory configured to store data on a plurality of electronic signature schemes; and
a processor configured to control the electronic device so that the electronic device performs a plurality of operations,
wherein the plurality of operations includes:
generating a first electronic signature from plaintext based on a first electronic signature scheme;
generating a second electronic signature from the plaintext based on a second electronic signature scheme; and
generating a multiple electronic signature using the first electronic signature and the second electronic signature,
both the first electronic signature scheme and the second electronic signature scheme are electronic signature schemes based on mathematical problems, and
a first mathematical problem on which the first electronic signature scheme is based mathematically differs from a second mathematical problem on which the second electronic signature is based.

2. The electronic device of claim 1, wherein the plurality of operations further includes:
storing selection information used to select two or more electronic signature schemes among the plurality of electronic signature schemes; and
selecting the first electronic signature scheme and the second electronic signature scheme among the plurality of electronic signature schemes based on the selection information.

3. The electronic device of claim 1, wherein the plurality of operations further includes selecting the first electronic signature scheme and the second electronic signature scheme among the plurality of electronic signature schemes based on information about the electronic device and information about the message.

4. The electronic device of claim 1, wherein the multiple electronic signature includes a result of concatenating the first electronic signature and the second electronic signature.

5. The electronic device of claim 4, wherein the multiple electronic signature further includes information indicating that at least two electronic signatures are included in the multiple electronic signature.

6. The electronic device of claim 4, wherein the multiple electronic signature further includes information about a time point when the multiple electronic signature is generated.

7. The electronic device of claim 1, wherein the first mathematical problem and the second mathematical problem are one of:
a lattice problem;
an elliptical curve problem;
a hash function problem;
a code problem;
a multiplicative-variable quadratic problem;
an isogeny problem;
an integer factorization problem;
a discrete logarithm problem;
a multiparty computation (MPC)-in-the head problem; and
a symmetric-based problem.

8. An electronic device comprising:
a communication device configured to exchange data with an external device;
a memory configured to store data on a plurality of electronic signature schemes; and
a processor configured to control the electronic device so that the electronic device performs a plurality of operations,
wherein the plurality of operations include:
receiving a multiple electronic signature;
identifying a first electronic signature based on a first electronic signature scheme from the multiple electronic signature and a second electronic signature based on a second electronic signature scheme; and
verifying one of the first electronic signature and the second electronic signature, both the first electronic signature scheme and the second electronic signature scheme are electronic signature schemes based on mathematical problems, and
a first mathematical problem on which the first electronic signature scheme is based mathematically differs from a second mathematical problem on which the second electronic signature is based.

9. The electronic device of claim 8, wherein the plurality of operations further includes:
receiving attack information indicating an unsecured electronic signature scheme;
determining a secure electronic signature among the first electronic signature and the second electronic signature based on the attack information; and
verifying only an electronic signature determined to be secured among the first electronic signature and the second electronic signature.

10. The electronic device of claim 8, wherein the plurality of operations further includes:
determining a generating time point when the multiple electronic signature is generated;
receiving attack information indicating an unsecured signature scheme when exceeding a predetermined period from the generating time point;
determining a secure electronic signature among the first electronic signature and the second electronic signature based on the attack information; and
verifying only an electronic signature determined to be secured among the first electronic signature and the second electronic signature.

11. The electronic device of claim 8, wherein each of the first mathematical problem and the second mathematical problem is one of:
a lattice problem;
an elliptical curve problem;
a hash function problem;
a code problem;
a multiplicative-variable quadratic problem;
an isogeny problem;
an integer factorization problem;
a discrete logarithm problem;
a multiparty computation (MPC)-in-the head problem; and
a symmetric-based problem.
